(19) United States
(12) Patent Application Publication
(10) Pub. No.: US 2025/0309662 A1
(43) Pub. Date: Oct. 2, 2025

(54) BALANCING MODULE FOR A POWER TOOL, POWER TOOL, AND CHARGE BALANCING METHOD

(71) Applicant: Hilti Aktiengesellschaft, Schaan (LI)

(72) Inventor: Michael LACHER, Schwabmuenchen (DE)

(21) Appl. No.: 18/865,752

(22) PCT Filed: May 4, 2023
(86) PCT No.: PCT/EP2023/061831

§ 371 Date: Nov. 14, 2024

(30) Foreign Application Priority Data
May 18, 2022 (EP) 22173946.9

(51) Int. Cl. H02J 7/00

(52) U.S. Cl. CPC H02J 7/0019; H02J 7/00032; H02J 7/00714

(57) ABSTRACT

A balancing module for a power tool is provided, wherein the power tool includes a motor, and at least a first and a second power supply device. The first power supply device is connected to a first switching element and a third switching element of the balancing module, and the second power supply device is connected to a second switching element and a fourth switching element of the balancing module, wherein a first and a second coil are arranged between the center tap of the power supply devices of the power tool and the switching elements of the balancing module, wherein the coils are configured such that a balancing current I_bal flows through the coils. A power tool with such a balancing module, as well as to a method for charge balancing between a first and a second power supply device of a power tool, wherein the balancing current I_bal flowing through the coils can be adjusted by appropriately controlling the switching elements of the balancing module.

The invention relates to a balancing module for a power tool, wherein the power tool comprises a motor, and at least a first and a second power supply device.

### BACKGROUND

Power tools with which different types of work can be carried out are known in the prior art. For example, hammer drills, chisels, cut-off or angle grinders, screwdrivers or core drills are known in each of which a tool is driven by a motor. A power supply can be provided via a mains connection or with power supply devices, batteries or accumulators.

### SUMMARY OF THE INVENTION

A number of applications of such power tools are known, in which high powers are required in order to carry out the corresponding work. In the case of power tools of which the power supply is formed by a power supply device, it may happen that the power required for the work exceeds the maximum possible output power of the power supply device. In order to meet this challenge, such power tools are often equipped with an interface for two power supply devices in order to be able to provide the desired power using two power supply devices that can be connected in series or in parallel.

However, when working with tool devices with two or more power supply devices, the following problem may occur: situations may arise in which the state of charge (“SOC”) of the power supply devices is not the same. A similar situation may also occur when different types of power supply devices are used, for example a 5 ampere-hour (Ah) power supply device and a 10 Ah power supply device. If, for example, one of the power supply devices is completely or partially discharged, full power cannot be provided for the power tool over the entire working period. As soon as one of the power supply devices is completely discharged, no further power can be drawn from this power supply device when the power supply devices are connected in series. It may then be necessary to stop working with the power tool—despite any remaining charge present in the other power supply device.

In particular, the energy or power available for work with the power tool is determined by the smallest amount of charge contained in one of the power supply devices when there are multiple power supply devices. In other words, the power supply device with the lowest SOC value determines the power available for the power tool and the range at which work can be performed with the power tool.

Methods are known in the prior art with which a charge balancing between electrical components in a power tool can be made possible. For example, U.S. Pat. No. 5,631,534 A discloses an arrangement of electronic components to allow charge balancing between battery cells connected in series. If such a balancing method is to be implemented at the device or accumulator level, a large number of components and plug connections are required for such an arrangement, for example various switching elements, drivers, inductors and current measuring devices. Such arrangements are complex to manufacture and prone to errors.

Another possibility of so-called balancing, i.e. equalization between the power supply devices, is to charge or discharge the power supply devices in a targeted manner. Here, in particular when charging the power supply devices, their state of charge SOC can be monitored. When a charge upper limit is reached, for example at SOC=100%, a bypass to the power supply device can be activated. This can be done, for example, by a resistor in which power is consumed so that overcharging of the power supply device is prevented. The resistor path remains activated until the state of charge of the power supply devices or their cells is equalized or balanced. With this variant of balancing, however, only the charge surplus in the resistor can be consumed. Technically, the application thus only makes sense with regard to the charging of the power supply device. For the use of this method in the area of the energy output of the power supply device, there is no technical advantage in respect of the range of the power supply device. Furthermore, this method is also not preferred from the point of view of sustainability.

The balancing methods known in the prior art are thus associated either with the disadvantage that the charge of the power supply devices cannot be used optimally if a power tool has several power supply devices which are connected in series and in which there is no active charge balancing between the power supply devices. When active discharge solutions are present, the charge surplus can often just be converted into unusable heat, for example by consuming the energy in a resistor.

It is an object of the present invention to overcome the above-described deficiencies and disadvantages of the prior art and to provide an improved power tool with at least two power supply devices and a method for carrying out a charge balancing between power supply devices in a power tool, with which the charge or energy provided in the power supply devices can be optimally used or made usable for the power tool. The arrangement of the power supply devices should be simple in the sense that as few components as possible are used.

The present invention provides a balancing module for a power tool, wherein the power tool comprises a motor, and at least a first power supply device and a second power supply device. The first power supply device is connected to a first switching element and a third switching element of the balancing module, and the second power supply device is connected to a second switching element and a fourth switching element of the balancing module, wherein a first and a second coil are arranged between a center tap of the power supply devices of the power tool and the switching elements of the balancing module, wherein the coils are configured such that a balancing current I_bal flows through the coils. With the invention, the charge available in the power supply devices can be made usable to a higher degree for the power tool, so that the energy contained in the power supply devices can be better utilized than in conventional balancing methods as are known from the prior art. Even though the balancing module and the balancing method are predominantly described for a power tool with two power supply devices, the power tool can of course also have more than two power supply devices. A plurality of balancing modules can then be provided in the power tool, wherein the balancing modules can then each be provided in the center taps between two power supply devices each. The invention relates in particular to a balancing module which is designed as a two-channel balancer.

It is very particularly preferred in the sense of the invention that the first coil is arranged between the center tap on one side and the first or the second switching element on the other side. Similarly, the second coil may be arranged between the center tap on one side and the third or fourth switching element on the other side.

A particular advantage of the invention is that charge balancing between the power supply devices can take place at all times, in particular regardless of whether or not the power tool is being operated. In other words, charge balancing between the power supply devices of the power tool can take place with the proposed balancing module or by the proposed balancing method even when the power tool is not currently being operated, i.e., when the power tool is not switched on. In particular, the charge balancing between the power supply devices can be performed before or during the operation of the power tool. By directly integrating the balancing module into the power tool, the balancing current I_bal can be optimally adapted to an operating state of the power tool. This optimization can be carried out in particular by taking into account the charging currents of the power supply devices. It is preferred in the sense of the invention that the proposed balancing module is capable of transferring energy from one power supply device of the power tool to another power supply device of the power tool. Advantageously, this allows a charge balancing to be effected between the power supply devices. The charge balancing takes place in particular by means of the balancing current I_bal.

In the sense of the invention, it is preferred that the balancing module has three power connections. Preferably, the balancing module may be connected to a negative terminal of the second power supply device, wherein this negative terminal of the second power supply device is preferably referred to as “ground” in the sense of the invention. Furthermore, the balancing module may be connected to a positive terminal of the first power supply device, wherein the bus voltage V+ is preferably applied to this positive terminal of the first power supply device. Furthermore, the balancing module may be connected to a so-called center tap between the power supply devices of the power tool. If the power tool has more than two power supply devices, preferably more than one center tap may also be provided in the power tool, wherein each center tap each is present between two power supply devices of the power tool. The center tap preferably represents a conductive connection between the power supply devices and the balancing module for the power tool, wherein in particular the balancing current I_bal flows through the center tap of the balancing module. The center tap preferably comprises the first coil of the balancing module, wherein the balancing current I_bal also flows through this first coil. It is preferred in the context of the present invention that the coil serves as an electromagnetic storage element.

The first switching element, the second switching element and the first coil of the balancing module form a first half-bridge, wherein the balancing current I_bal can be adjusted by controlling the half-bridge. In the sense of the invention, the proposed balancing module can preferably also be referred to as a balancer. In the case of a “single-channel balancer”, the balancing module may comprise a half-bridge with two switching elements, wherein the half-bridge may be connected to the center tap between the power supply devices via a coil. The balancing module according to the invention comprises at least a second half-bridge, so that the balancing module according to the invention is referred to as a “two-channel balancer”. In the case of two half-bridges, it is particularly preferred in the sense of the invention that the two half-bridges are operated out of phase, i.e., in a complementary manner. In addition, it may also be preferred in the sense of the invention that the balancer is formed from a further n channels and is then referred to accordingly as an “n-channel balancer”. The switching elements of the balancing module may be formed by field-effect transistors (FET) or insulated gate bipolar transistors (IGBT), i.e., switching devices or switches. Furthermore, it may also be preferred that one of the two switching elements is formed by a diode. By replacing one of the switching elements by a diode, the complexity of the balancing modules can be reduced and particularly low-cost balancing modules can be obtained.

It is preferred in the sense of the invention that the first half-bridge can be controlled in such a way that a desired balancing current I_bal is established in the first coil of the balancing module. In other words, the balancing current I_bal in the first coil can be adjusted by appropriately controlling the first switching element and the second switching element of the balancing module. In the sense of the invention, this preferably means that the switching elements of the half-bridge may be opened and closed for example at staggered times with respect to each other. Of course, the switching elements may also both be open. If, for example, —as shown in FIG. 2—the second power supply device has a higher voltage than the first power supply device, the desired balancing current I_bal in the first coil may be charged from the second power supply device when the second switching element is closed and discharged by switching to the first switching element in the first power supply device. Here, the second switching element is preferably opened, whilst the first switching element is closed.

The balancing module comprises a second half-bridge, wherein the second half-bridge has a third switching element and a fourth switching element, and also a second coil. The second half-bridge is preferably connected via the second coil to the center tap of the balancing module, so that a “two-channel” balancing module is obtained. In other words, the first power supply device is connected to a first switching element and a third switching element of the balancing module, whilst the second power supply device is connected to a second switching element and a fourth switching element of the balancing module. The center tap of the balancing module is arranged between the power supply devices, wherein a first and a second coil are arranged between the center tap of the power supply devices of the power tool and the switching elements of the balancing module and are configured such that a balancing current I_bal flows through the coils. In this preferred embodiment of the invention, the balancing current I_bal is preferably divided across the first coil and the second coil of the balancing module. Similarly to the switching elements of the first half-bridge, the switching elements of the second half-bridge can also each be connected to a positive terminal and a negative terminal of the power supply devices. In addition, the second half-bridge can be connected with the aid of the second coil to the center tap between the power supply devices so that the balancing current I_bal can likewise be divided across the first and the second coil. By providing the second half-bridge and a preferably out-of-phase, i.e., complementary switching in a balancing module, a particularly smooth current profile can be made possible. This is the case in particular during recharging, i.e., when charging the power supply device of lower state of charge by the power supply device of higher state of charge. A smooth current profile is characterized in the context of the present invention in particular by a low ripple current. Here, the ripple current preferably represents an AC component in a current. The AC component represents a fluctuation in an otherwise substantially constant DC current, wherein these undesirable fluctuations can be significantly reduced by the invention.

For the purposes of the invention, it is preferred that the first half-bridge and the second half-bridge are controllable in a staggered manner with respect to one another. The term “staggered” is understood to mean “out-of-phase” in the sense of the invention. The staggered control of the two half-bridges of the proposed balancing module can further contribute to significantly reducing the undesirable AC fluctuations in the otherwise substantially constant DC current.

It is preferred in the sense of the invention that the first and the second half-bridge are controllable out-of-phase by 180°, i.e., in a manner complementary to one another. It may also be preferred in the sense of the invention that the first half-bridge and the further half-bridges can be controlled out of phase with each other.

In the sense of the invention, it may also be preferred that the balancing module comprises n further half-bridges with two switching elements each, as well as further coils, wherein the further half-bridges are connected to a center tap of the balancing module via the further coils. Advantageously, the balancing current I_bal can be divided here across the further coils.

In a second aspect, the invention relates to a power tool comprising a motor, and at least a first and a second power supply device, wherein the power tool comprises a balancing module according to one of the preceding claims. The definitions, technical effects and advantages described for the proposed balancing module apply analogously to the power tool and the later described balancing or charge balancing method.

It is preferred in the sense of the invention that the balancing current I_bal is calculated according to the following formula:

$$I\_bal = - I\_b 1 + I\_b 2 + / - I\_Motor ,$$

wherein I_b1 is the permissible charging current of the first power supply device and I_b2 is the permissible charging current of the second power supply device and I_Motor is the drive current flowing through the motor of the power tool. In other words, the possible balancing current I_bal can be determined from the permissible charging currents of the power supply devices of the power tool, as well as from the motor current I_Motor of the power tool. The current I_Motor of the power tool preferably represents the current flowing into the power tool to drive the motor, wherein this current I_Motor preferably does not correspond to the motor phase current. It is preferred in the sense of the invention that the current I_Motor of the power tool is considered in dependence on the states of charge SOC of the power supply devices.

It is preferred in the sense of the invention that the power tool comprises communication means, wherein the communication means allows an exchange of information between the power supply devices, a drive unit of the power tool and/or the balancing module. Preferably, the drive unit comprises the motor of the power tool. The communication function of the power supply devices can in particular be taken over or performed by a battery or cell management system (BMS or CMS), wherein the battery or cell management system is preferably configured to control the power supply devices, their cells, and also the energy consumption and/or energy output of the power supply devices.

In particular, if the power tool comprises more than two power supply devices, it is preferred in the sense of the invention that the balancing modules are arranged in a cascading manner within the power tool. The term “cascading” is understood in the sense of the invention to mean that each balancing module spans two power supply devices. A corresponding cascading arrangement of balancing modules is illustrated in FIG. 4. For example, in the cascading arrangement of balancing modules, the first balancing module is connected to the positive terminal of the first power supply device, the negative terminal of the second power supply device, and the center tap between the first and second power supply devices via corresponding power connections.

The power connection of the first balancing module, which is connected to the negative terminal of the second power supply device, at the same time represents the center tap of the second balancing module. In addition, the second balancing module can be connected to the center tap between the first power supply device and the second power supply devices via corresponding power connections, and also to the negative terminal of the third power supply device. Due to the cascaded arrangement of the balancing modules, the design of the individual balancing modules can be kept particularly simple, so that the complexity of the component can be reduced and costs can be saved.

It is preferred in the sense of the invention that the balancing modules are capable of transferring energy in both directions. This means in the sense of the invention preferably that, for example, the n-th balancing module is able to transfer energy from the n-th to the (n+1)-th power supply device as well as from the (n+1)-th power supply device to the n-th power supply device.

Furthermore, the final balancing module, which may preferably be referred to as the n-th balancing module in the sense of the invention, can be configured to consume any energy surplus. To consume any energy surplus, a resistor can be provided in the diode path of the balancing module. Preferably, the invention can span a pack of cells within the power supply device. A balancing module, as proposed in the context of the present invention, may advantageously be used to balance charges between power supply devices, for example in a power tool.

Thus, a cascading arrangement of balancing modules in a power tool is disclosed, wherein each balancing module has at least two switching elements, which can be designed as switches or as diodes. The balancing modules can be arranged in the power tool such that each balancing module spans two power supply devices. For example, in the exemplary embodiment of the invention shown in FIG. 4, the first balancing module spans the first and second power supply device, whilst the second balancing module spans the second and third power supply device.

In one exemplary embodiment of the invention, the balancing modules each have three power connections V+ (bus voltage), V− (ground) and V_center (center tap). The balancing modules can each have one or more channels, i.e., can be of single-channel or multi-channel design. It is preferred in the sense of the invention that a channel comprises a coil and a half-bridge. A multi-channel balancer can thus comprise a plurality of functional blocks formed of a coil and a half-bridge, wherein the functional blocks are preferably referred to as a “channel” in the sense of the invention. According to one exemplary embodiment of the invention, the balancing modules can comprise a first and a second switching element, wherein the switching elements can be formed, for example, as MOSFETs. Preferably, one of the switching elements may be formed as a diode. Furthermore, a coil with an inductance L is provided in the balancing modules.

In a further aspect, the invention relates to a method for charge balancing between a first power supply device and a second power supply device in a power tool having a motor, wherein the balancing method is characterized by the following method steps:
a) providing a balancing module
comprising a first switching element and a third switching element, wherein the first and third switching elements are connected to the first power supply device, and
comprising a second switching element and a fourth switching element, wherein the second and fourth switching elements are connected to the second power supply device,
b) providing a first coil and a second coil between a center tap of the power supply devices and the switching elements,
c) adjusting a balancing current I_bal in the first and in the second coil by appropriately controlling the switching elements of the balancing module.

It is preferred in the sense of the invention that the balancing current I_bal is divided across the first coil and a second coil if the balancing module comprises two half-bridges and two coils, wherein the second coil connects a second half-bridge of the balancing module to a center tap of the balancing module. The second half-bridge has a third and a fourth switching element. It is very particularly preferred in the sense of the invention that the first half-bridge and the second half-bridge can be controlled in a staggered manner with respect to one another, i.e. out of phase. It may also be preferred in the sense of the invention that the half-bridges are controlled out-of-phase with each other to minimize the current ripple through the power supply devices.

It is preferred in the sense of the invention that the first and the second coils of the balancing module are present between the power supply devices and the switching elements of the balancing module. Preferably, the balancing current I_bal can be adjusted in particular by appropriately controlling the first and/or the second switching element of the balancing module. Of course, it is also possible that the balancing current I_bal is adjusted by appropriately controlling the third and/or the fourth switching element of the balancing module. In other words, the balancing current I_bal can be adjusted by appropriately controlling the switching elements of the balancing module.

In a further method step, a setpoint value of the balancing current I_bal can be determined from the operating state of the power supply devices. The operating state of the power supply device may depend, for example, on a voltage, a state of charge and/or a temperature of the power supply device. The setpoint value of the balancing current I_bal is determined from the operating state of the power supply devices preferably with the objective of optimum energy withdrawal from the power supply device and the associated complete discharge of the power supply device.

It is preferred in the sense of the invention that in the sense of the present invention not only a charge balancing between the power supply devices of the power tool takes place. Rather, the term “charge balancing” is understood more broadly in the sense of the invention, so that a balancing of temperatures or aging conditions can also be performed with the invention. It is preferred in the sense of the invention that currents flow due to the charge balancing, wherein uneven current loads may also result in different heat distributions. Advantageously, the power supply device may be controlled in dependence on its state of charge and/or the temperatures in the cells, such that the charge withdrawal is maximized before a cut-off limit is reached by the balancing module.

In the sense of the invention, it is preferred that the power supply devices of which the states of charge are to be balanced have the same or substantially identical nominal voltages. However, it may also be preferred in the sense of the invention for the power supply devices to have different nominal voltages. For example, in the context of the present invention, two different power supply devices having voltages of 12 V and 36 V may be present with each other in a power tool. In such combinations of power supply devices with different balancing voltages, it may be desired that the power supply devices have equal or substantially equal states of charge after the balancing process. However, it may also be preferred that the states of charge merely balance each other out. The term “balance” preferably means, in the sense of the invention, that a difference in the states of charge between the power supply devices is reduced.

In the sense of the invention, it is preferred that the power supply devices may be present connected in series within the power tool. Series connection of the accumulators is particularly preferred here in order to double the power to be provided while maintaining the same currents. In addition, an uncontrolled charge balancing between the accumulators is avoided in the case of a series connection. Such an undesirable, uncontrolled charge balancing may occur when different initial voltages of the accumulators are present.

The invention allows all of the energy stored in the power supply devices to be converted and used to operate the power tool. Advantageously, this allows the running time of the power tool to be extended without having to replace or recharge the power supply devices.

### BRIEF DESCRIPTION OF THE DRAWINGS

Further advantages can be found in the following description of the figures. An exemplary embodiment of the present invention is shown in the figures. The figures, the description and the claims contain numerous features in combination. A person skilled in the art will expediently also consider the features individually and combine them to produce useful further combinations.

Identical and similar components are denoted by the same reference signs in the figures,
in which:

FIG. 1 shows a schematic illustration of a balancing module for a power tool

FIG. 2 shows a schematic illustration of a single-channel balancer

FIG. 3 shows a schematic illustration of an exemplary embodiment of the proposed balancing module as a two-channel balancer

FIG. 4 shows a schematic illustration of an exemplary embodiment of a cascading arrangement of balancing modules in a power tool

FIGS. 5a and 5b show schematic illustration of two exemplary embodiments of a balancing module

### DETAILED DESCRIPTION

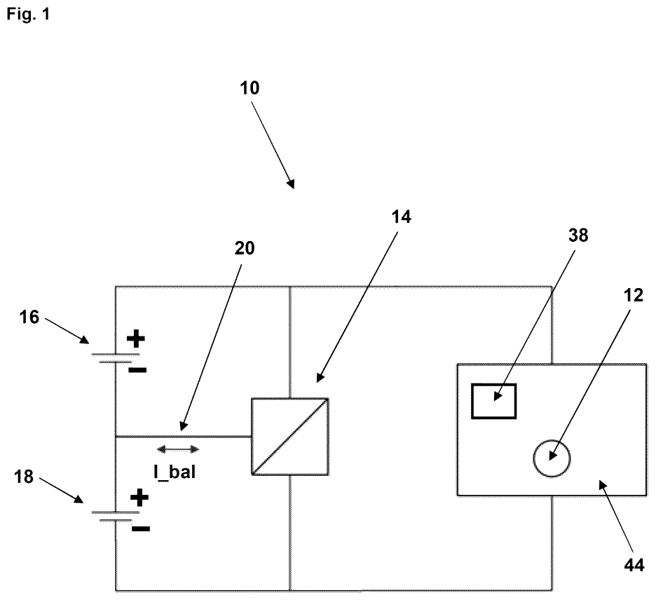

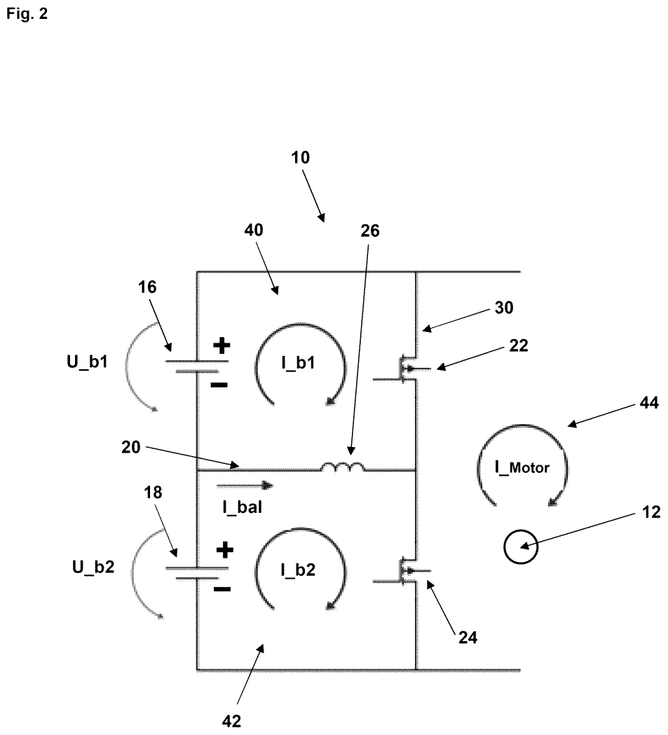

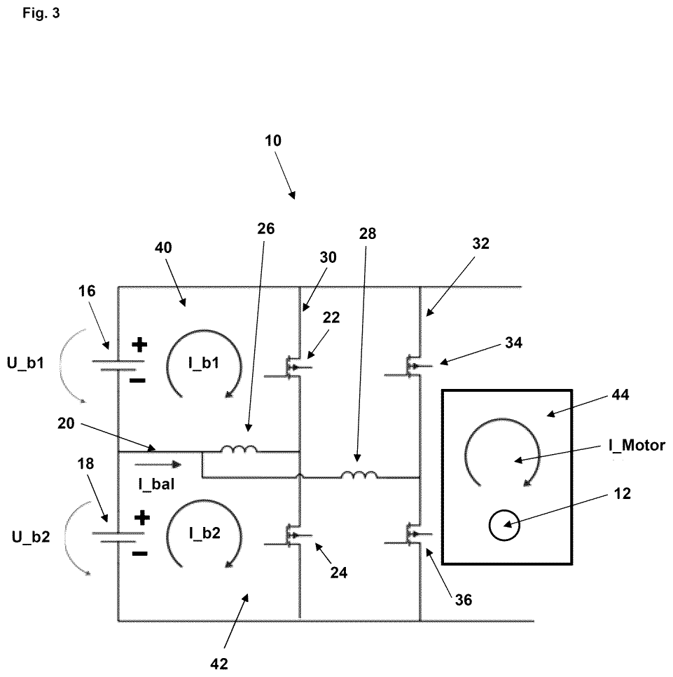

FIG. 1 shows a balancing module 14 for a power tool 10. The power tool 10 has a first power supply device 16 and a second power supply device 18, and a motor 12. The motor 12 can be integrated in a drive unit 44 of the power tool 10. In addition, the power tool 10 may include communication means 38 for enabling an exchange of information between the power supply devices 16, 18, the drive unit 44, and a balancing module 14. The balancing module 14 is shown schematically as a black box in FIG. 1. Details of possible embodiments of the balancing module 14 are shown in FIGS. 2 and 3. Arranged between the power supply devices 16, 18 is the center tap 20, which preferably comprises a first coil 26 (not shown in FIG. 1; see FIGS. 2 and 3). The balancing current I_bal can flow through the center tap 20. In the exemplary embodiment of the invention shown in FIG. 1, the center tap 20 is connected to the negative terminal of the first power supply device 16 and the positive terminal of the second power supply device 18 of the power tool 10. The balancing module 14 has three power connections connected to the center tap 20, as well as the positive terminal of the first power supply device 16 and the negative terminal of the second power supply device 18 of the power tool 10. The positive terminals of the power supply devices 16, 18 are denoted with a plus sign in the figures, while the negative terminals of the power supply devices 16, 18 are denoted with a minus sign.

FIG. 2 shows a schematic representation of a single-channel balancer. The balancing module 14 shown in FIG. 2 has a first half-bridge 30 having a first switching element 22 and a second switching element 24. The first switching element 22, the first power supply device 16 and the center tap 20 or the first coil 26 form a first circuit 40, in which the first current I_b1 can flow. The preferably negative first current I_b1 preferably represents the maximum allowable charging current of the first power supply device 16. The second switching element 24, the second power supply device 18 and the center tap 20 or the first coil 26 form a second circuit 42, in which the second current I_b2 can flow. The preferably negative second current I_b2 preferably represents the maximum permissible charging current of the second power supply device 18. A first voltage U_b1 is applied to the first power supply device 16, while a second voltage U_b2 is applied to the second power supply device 18. The balancing current I_bal flows through the center tap 20 or the first coil 26. The balancing module 14 may be present integrated in a power tool 10, wherein the power tool 10 may additionally comprise a drive unit 44 and a motor. The current flowing from the power supply devices 16, 18 and/or through the balancing module 14 into the motor 12 of the power tool 10 is referred to as I_Motor in FIGS. 2 and 3.

FIG. 3 shows a schematic illustration of an exemplary embodiment of the preposed balancing module 14 as a two-channel balancer. In addition to the components of the power tool 10 or balancing module 14 shown in FIG. 2, a second half-bridge 32 is shown in FIG. 3, which includes a third switching element 34 and a fourth switching element 36. The second half-bridge 32 is part of a preferred embodiment of the balancing module 14 and can be connected to the center tap 20 between the first power supply device 16 and the second power supply device 18 of the power tool 10 via a second coil 28.

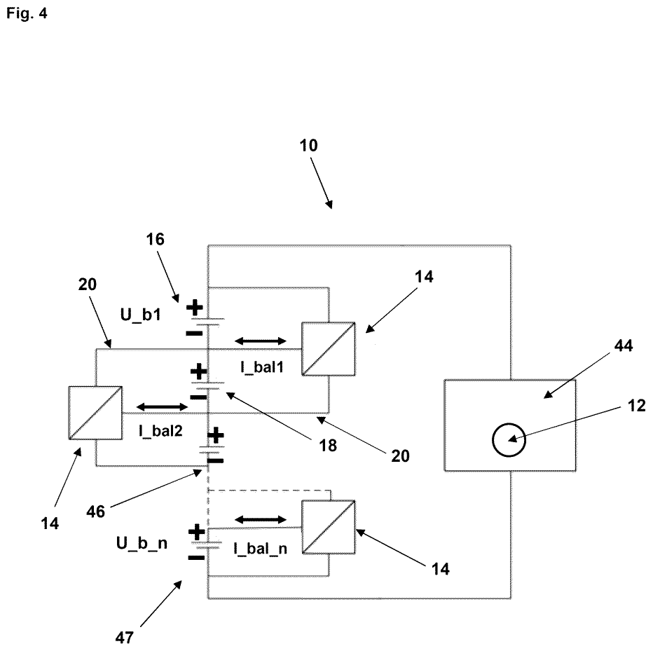

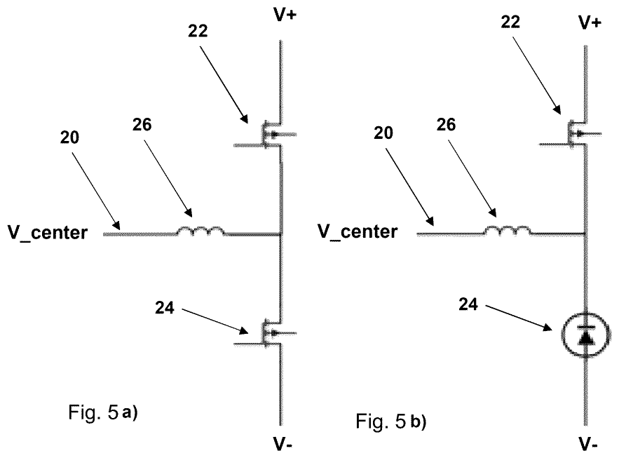

FIG. 4 shows a schematic illustration of an exemplary embodiment of a cascading arrangement of balancing modules 14 in a power tool 10. The circuit shown in FIG. 4 has a first power supply device 16, a second power supply device 18, a third power supply device 46, and further power supply devices 47. In addition, the circuit shown in FIG. 4 has three balancing modules 14, in particular a first balancing module (top), a second balancing module (middle), and an n-th balancing module (bottom). Each balancing module 14 has three power connections, namely a connection to a positive terminal + of a power supply device 16, 18, 46 (V+, bus voltage), a connection to a negative terminal + of a power supply device 16, 18, 46 (V−, ground) and a connection to a center tap 20 between each two power supply devices 16, 18, 46 (V_center). These three power connections are also shown in FIG. 5, wherein FIG. 5 shows, in its sub-FIGS. 5a) and 5b), schematic illustrations of exemplary embodiments of the proposed balancing module 14.

In the exemplary embodiment of the invention shown in FIG. 4, the balancing modules 14 each span two power supply devices 16, 18, 46, wherein the first balancing module 14 (top) spans, for example, the first power supply device 16 and the second power supply device 18. The second balancing module 14 (center) spans, for example, the second power supply device 18 and a third power supply device 46, while an n-th balancing module 14 (bottom) spans, for example, the n-th power supply device 46 and an (n+1)-th power supply device 47. The voltages U_b1, Ub2 and U_b_n are applied to each of the power supply devices 16, 18, 46, respectively. The power supply devices 16, 18, 46 each have a positive terminal+ and a negative terminal −, wherein the positive terminals are marked with a “+” in FIG. 4 and the negative terminals with a “−”. A balancing current I_bal flows through the center taps 20 between each two power supply devices 16, 18, 46, wherein, for example, the first balancing current I_bal_1 flows through the center tap 20 between the first power supply device 16 and the second power supply device 18.

FIGS. 5a and 5b show possible embodiments of the proposed balancing module 14. FIG. 5a shows a balancing module 14 with a first switching element 22 and a second switching element 24, wherein both switching elements 22, 24 can be formed as MOSFETs. FIG. 5b shows a balancing module 14 with a first switching element 22, which may be formed as a MOSFET, for example, while the second switching element 24 is formed as a diode. In addition to the switching elements 22, 24, the balancing modules 14 shown in FIG. 5 each comprise a coil 26, which is arranged in a center tap 20. The balancing current I_bal flows through this center tap 20 or through the coil 26 in each case. The first switching element 22 of the balancing module 14 is connected in each case to the power connection V+, whilst the second switching element 24 of the balancing module 14 is connected to the power connection V−. In addition, the balancing module 14 has a third power connection V_center, which is connected to the center tap 20.

### LIST OF REFERENCE SIGNS

10 power tool
12 motor of the power tool
14 balancing module
16 first power supply device
18 second power supply device
20 center tap
22 first switching element
24 second switching element
26 first coil
28 second coil
30 first half-bridge
32 second half-bridge
34 third switching element
36 fourth switching element
38 communication means
40 first circuit
42 second circuit
44 drive unit
46 third power supply device
47 further power supply device

What is claimed is:

1-14. (canceled)

15: A balancing module for a power tool, the power tool having a motor, a first power supply device and a second power supply device, the balancing module comprising:
a first switching element, a second switching element, a third switching element, and a fourth switching element, the first power supply device being connected to the first switching element and the third switching element, and the second power supply device being connected to the second switching element and the fourth switching element;
a first coil and a second coil arranged between a center tap of the first and second power supply devices and the first, second, third and fourth switching elements, the first and second coils configured such that a balancing current flows through the first and second coils, the first switching element, the second switching element and the first coil forming a first half-bridge and the third switching element, the fourth switching element and the second coil forming a second half-bridge.

16: The balancing module as recited in claim 15 wherein the first coil is arranged in the center tap of the balancing module, the center tap being arranged between the power supply devices of the power tool.

17: The balancing module as recited in claim 15 wherein the balancing current is adjustable by controlling the first half-bridge.

18: The balancing module as recited in claim 15 wherein the second half-bridge is connected to the center tap via the second coil.

19: The balancing module as recited in claim 15 wherein the balancing current I_bal is divided across the first coil and the second coil.

20: The balancing module as recited in claim 15 wherein the first half-bridge and the second half-bridge are controllable in a staggered manner with respect to one another.

21: The balancing module as recited in claim 15 wherein a first circuit is formed by the first power supply device, the first switching element and the first coil, wherein a first current flows in the first circuit, wherein the first current is the permissible charging current of the first power supply device.

22: The balancing module as recited in claim 21 wherein a second circuit is formed by the second power supply device, the second switching element and the first coil, wherein the second current flows in the second circuit, wherein the second current is the permissible charging current of the second power supply device.

23: The balancing module as recited in claim 15 wherein a second circuit is formed by the second power supply device, the second switching element and the first coil, wherein the second current flows in the second circuit, wherein the second current is the permissible charging current of the second power supply device.

24: A power tool comprising:
the balancing module as recited in claim 15;
the motor;
the first power supply device; and
the second power supply device.

25: The power tool as recited in claim 24 wherein the balancing current I_bal is calculated by the following formula:
I_bal=−I_b1+I_b2+/−I_Motor,
wherein I_b1 is the permissible charging current of the first power supply device and
I_b2 is the permissible charging current of the second power supply device and
I_Motor is the drive current flowing through the motor of the power tool.

26: The power tool as recited in claim 24 further comprising a communication connection for an exchange of information between the first and second power supply devices, a drive unit of the power tool or the balancing module.

27: A method for charge balancing between a first power supply device and a second power supply device in a power tool having a motor, the balancing method comprising the steps of:
a) providing a balancing module having a first switching element and a third switching element, wherein the first switching element and third switching element are connected to the first power supply device, and having a second switching element and a fourth switching element, wherein the second switching element and fourth switching element are connected to the second power supply device;
b) providing a first coil and a second coil between a center tap of the first and second power supply devices and the first, second, third and fourth switching elements;
c) adjusting a balancing current in the first coil and in the second coil by controlling the the first, second, third and fourth switching elements of the balancing module;
wherein the first switching element, the second switching element and the first coil form a first half-bridge, and wherein the third switching element, the fourth switching element and the second coil form a second half-bridge for the balancing module.

28: The method as recited in claim 27 wherein the balancing current is distributed across the first coil, the second coil or further coils, wherein the first and second half-bridges are connected to the center tap of the balancing module via the first and second coils.

29: The method as recited in claim 28 wherein the first half-bridge and the second half-bridge are controlled in a staggered manner with respect to one another.
